(19) United States
(12) Patent Application Publication
(10) Pub. No.: US 2009/0075000 A1
(43) Pub. Date: Mar. 19, 2009

(54) Method and apparatus for providing sanitary shields for exercise devices

(76) Inventors: Alexander Draghici, Santa Monica, CA (US); Angela Ryzner, Santa Monica, CA (US)

Correspondence Address: I. Michael Bak-Boychuk;Attorney at Law, P.O. Box 32501, Long Beach, CA, 90832, US

(21) Appl. No.: 11/901,396

(22) Filed: Sep. 17, 2007

(51) Int. Cl. B32B 1/08; B65H 16/00

(52) U.S. Cl. 428/35.2; 242/550

(57) ABSTRACT

A plurality of dispensers of thin polymeric envelopes are distributed throughout a public exercise facility whereby the users can extract the envelopes to cover the contact areas of the exercise device that they will be using. When finished, the shielding envelopes are removed and discarded into a collection receptacle to be thereafter recycled. Preferably the envelopes are formed of a thermoplastic polymer structure and are therefore sterilized directly in the course of recycling. Each envelope may include a transparent portion that can be aligned over various exercise data displays and may be provided with a releasable attachment by which it is retained during its use.

### BACKGROUND OF THE INVENTION

1. Field of the Invention

The present invention relates to protective coverings for exercise equipment, and more particularly to dispensing of discardable shielding membranes useful in public exercise facilities to shield the handles or other grasping areas of exercise machines from direct contact with the user and the collection thereof for recycling.

2. Description of the Prior Art

As the knowledge base relating to the proper methods for circulatory and muscular development increases the variety of specialized exercise devices addressing one or another developmental aspect of human physiology has also increased and a limited complement of exercise machines is no longer appropriate. With all the equipment refinements that are now available one simply cannot settle for an incorrect exercise device to address a particular muscular deficit when a better device is available. In consequence various public exercise facilities have appeared each equipped with the latest devices as a matter of commercial imperative, the cost of these device complements then shared by the subscribing membership or sometimes by per-use payments from the visiting public.

With the shared use of these variously specialized exercise devices come other concerns including fears of transmission of contagious diseases. A vigorously used exercise machine that is invariably exposed to human contact will include large surface areas drenched by the user's sweat, breathing vapors and the like and as the membership grows to spread the costs of the expanding device complement so does the associated incidence of possible disease transfer. As result the subject of variously implemented sanitary and prophylactic techniques is now a common event and variously implemented mechanisms and devices have been proposed in the prior art.

Amongst the various solutions offered in the prior art the most frequent approach has been to devise conformingly shaped wraps or sheaths that are mounted on and thereafter removed from the particularly shaped grasping or contacting surfaces of the exercise device, as exemplified by the teachings in U.S. Pat. No. 6,220,997 issued to Kohl. While suitable for the purposes intended, these and similar closely conformed covers require some manipulation thereof during their installation and removal with some risk of inadvertent transfer from the covered device surface to the cover surfaces touched by the user. More importantly, the conforming nature of these prior art covers multiplies inventory concerns that are particularly exacerbated when new exercise devices are brought into the commercial facility.

Alternatively, various loose covering sheets and absorbent towels have been proposed in the prior art, as exemplified in the teachings of published US patent applications 2007/0099779 by Boehm, Jr. et al.; and 2006/0189463 by Boice et al., which are loosely wrapped or laid onto the contact surfaces of the exercise device prior to use. Again, while suitable for the purposes intended, the loose mounting and the wicking nature of the covering material do not fully assure insulation from all possible manners of contact transfer and even the removal and discarding process thereof entails possible disease carrier transfer.

Those skilled in the art will appreciate that any business addressing the wellbeing of its patrons, like the exercise business, needs to create conditions that will insure that result for several commercial reasons. Moreover, this assurance needs to be immediately perceivable, convenient and clearly effective to assure the patrons that all efforts are taken to avoid all their risks that are incident to exercise sharing. Of course, these perceptions are most effective when presented in familiar settings like those currently associated with the widespread concern over the proper disposal of plastic shopping bags.

Proper recycling of plastic shopping bags is a matter of current social attention and in fact is now mandated in many states (e.e., the State of California as of July 2007 mandates that all retailing outfits that utilize plastic bags also provide for their collection and recycling.) This recycling process inherently effects sterilization since heat is a necessary part thereof. A method and mechanism that assure by familiar associations these sanitary results is therefore extensively desired and it is one such mechanism and process that is disclosed herein.

### SUMMARY OF THE INVENTION

Accordingly, it is the general purpose and object of the present invention to provide a dispensing and collection process for thin polymeric film bags each fitted with a closure that is selectively securable once positioned on an exercise device.

Other objects of the invention are to provide a thin polymeric film enclosure for the contact areas of an exercise device that includes translucent portions useful for viewing such informational displays as may be included in the device.

Yet further objects of the invention are to provide a convenient dispensing and collection process useful with shared exercise devices.

Yet other objects of the invention are to provide shielding enclosures for exercise machinery that entail minimal contact in the course of placement and collection thereof.

Briefly, these and other objects are accomplished within the present invention by providing a generally rectangular thin polymeric film envelope closed along three edges and including a captured draw string in the film folds adjacent the fourth, open edge. Preferably each envelope is dimensioned for convenient receipt of those portions of an exercise device that are contacted by the user and when arranged on the shielded portion the draw string can be extended and tied to retain the envelope in position during use. Each envelope may also include one or more translucent panels or film portion through which any informational displays on the exercise device can be viewed, thus assuring its full use convenience.

In this form the envelopes can be wound in an interleaved and folded arrangement to form a dispensing roll received within a cylindrical housing provided with a lateral dispensing window, so that when one of the envelopes is withdrawn the edge of the next one is exposed. These continuous supplies of interleaved shielding envelopes are then distributed throughout the exercise facility along with collection receptacles into which the used envelopes are discarded to be then collected, reprocessed and thereafter recycled back into use.

It will be appreciated that the flexible nature of the thin polymeric film from which each envelope is formed will conform well to those areas of the exercise device that are contacted by the user with little relative motion. Exercise devices that include large force strokes are usually associated with leg exercise devices like stationary bicycles or treadmills resolve most of the large forces at the soles of the user's feet and therefore expose the other contact areas to forces that are mainly there to retain balance. Where some other large forces are entailed, such as those across the upper body back surface in a bench press, such are usually associated with little motion and therefore little wear on the isolating membrane. Thin film polymeric membranes are therefore quite adequate for the isolating task.

Moreover, the use of thin film polymeric bags as the isolating membranes also invokes well known recycling processes which predominantly rely on heat and therefore are sterilized right in the course of recycling. In this manner all the sanitary and environmental concerns are combined in a single device and process that are more fully described in conjunction with the drawings summarized below.

### BRIEF DESCRIPTION OF THE DRAWINGS

FIG. 1 is a perspective illustration of an inventive isolating envelope in the course of its installation onto the handlebars of a stationary bicycle together with an inventive dispensing assembly and an associated recycling receptacle useful in the inventive process described herein;

FIG. 2 is a further perspective illustration separated by parts of the inventive isolating envelope in its dispensed form;

FIG. 3 is a perspective detail view of the inventive isolating envelope in its installed configuration on the seat of an exercise device;

FIG. 4 is a sectional top view of the inventive dispensing assembly taken along line 4-4 of FIG. 1; and

FIG. 5 is a sequence diagram illustrating the sequence of steps carried out in accordance with the inventive process described herein.

### DESCRIPTION OF THE PREFERRED EMBODIMENTS

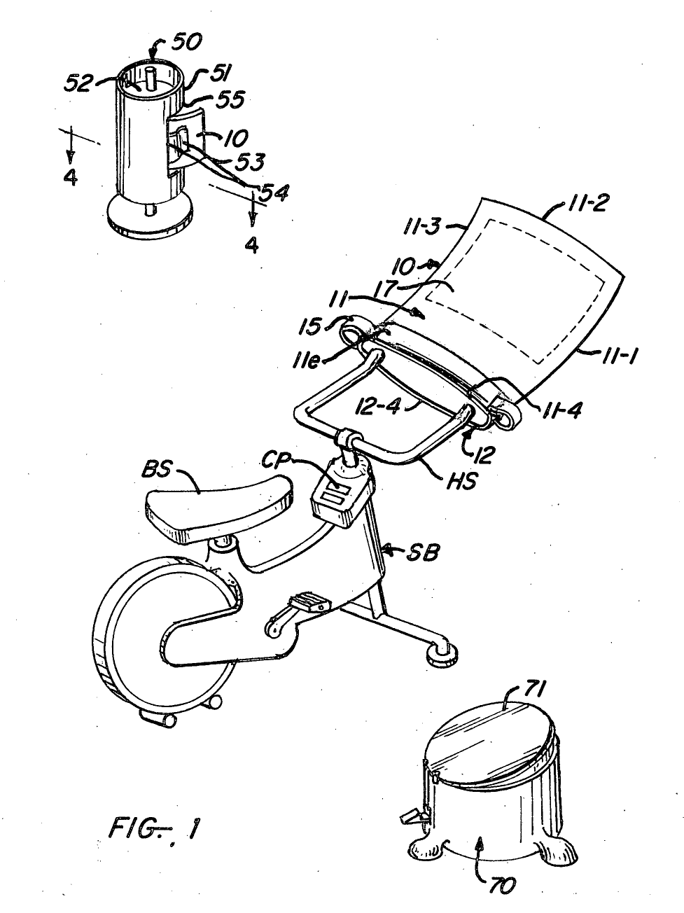

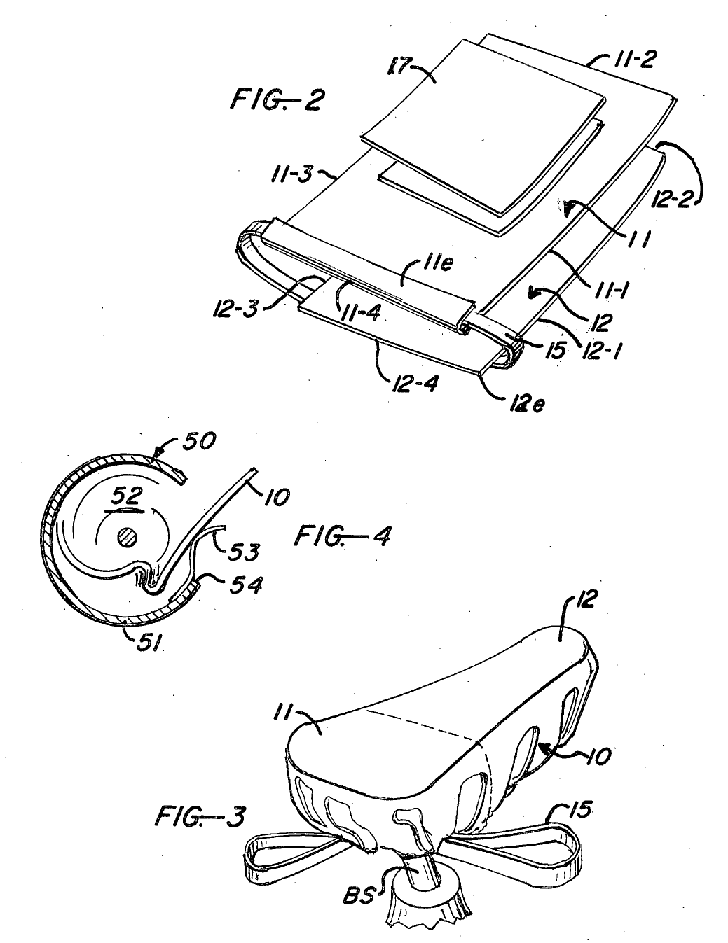

As shown in FIGS. 1 and 2 the inventive isolating envelope, generally designated by the numeral 10, comprises a substantially rectangular upper polymeric membrane 11 joined along three edge segments 11-1, 11-2 and 11-3 defining its rectangular periphery to corresponding edge segments 12-1, 12-2 and 12-3 of an equally sized lower polymeric membrane 12. The fourth edges 11-4 and 12-4 of each of the membranes 11 and 12 are then left unjoined as folded-over edge folds 11e and 12e within which one or more loops of a draw band 15 is received. In this manner a containment envelope is formed provided with an opening between the folds 11e and 12e, along edges 11-4 and 12-4, through which various articles can be inserted into its interior.

Preferably the planform of each of the membranes 11 and 12 forming the isolating envelope 10, and also the width of the opening formed between the edges 11-4 and 12-4, are dimensioned to receive one of the portions of an exercise device that is subject to the user's contact. By specific reference to a stationary bicycle SB such contact areas would include the whole of the handlebar structure HS and also the bicycle seat BS, together with any control and display panel CP that may be provided. Since the stationary bicycle SB is useful at various levels of exercise vigor the form of each of these contact areas needs to accommodate the necessary contact geometry through the whole of the vigor range, and the handlebar structure HS, in particular, is conformed as a fairly large generally rectangular framework provided with the varying contact areas needed through all the exercise postures.

Once in position, as illustrated in FIG. 3, the draw band 15 may be pulled out and tied to secure the envelope in a surrounding placement around the contact area shielded. Since the shielded area may also include the display panel CP membrane 11 may be formed of a translucent or transparent film or may include a translucent portion or section 17 to allow viewing of any displays and/or manual access to any subjacent controls. It will be appreciated that this panel combination may be conveniently formed from polymeric film materials, like those utilized in plastic shopping bags, fused and cut by known methods like hot wire welding into the shape and form of envelope 10. The known recycling processes that inherently include heat will then be useful both to sterilize any used envelopes and to reprocess them into the film stock from which new ones are again made.

To assure a continuing dispensing, use, collection and thereafter recycling of the foregoing envelopes 10 a plurality of dispensing assemblies, generally designated by the numeral 50, may be distributed throughout the exercise facility in convenient proximity to various exercise device groupings. Associated therewith may also be various collection receptacles 70 into which the used envelopes 10 are discarded, to be thereafter collected and recycled. In this manner most disease transmission paths are effectively controlled in a process that takes benefit of the current developments, and cost advantages, of plastic shopping bag recycling.

By particular reference to FIGS. 1 and 4, the dispensing assembly 50 may include a generally cylindrical housing 51 in which a roll 52 of interleaved envelopes 10 is mounted in alignment to be radially compressed against a spring biased dispensing leaf 53 along one vertical edge 54 of a dispensing window 55 in the exterior of housing 51. The interleaved arrangement of the envelopes 10 is such that the closed edges 11-2 and 12-2 of the inner envelope are folded into the open edges 11-4 and 12-4 of the next envelope, and once one envelope is dispensed the next one is pulled out past the leaf 53. In this manner the opening in the next envelope is exposed through the dispensing window 55 after each prior dispensing. Of course the collection receptacle 70 may be conventionally implemented to include a foot pedal articulated lid 71 to limit all instances of contact contamination.

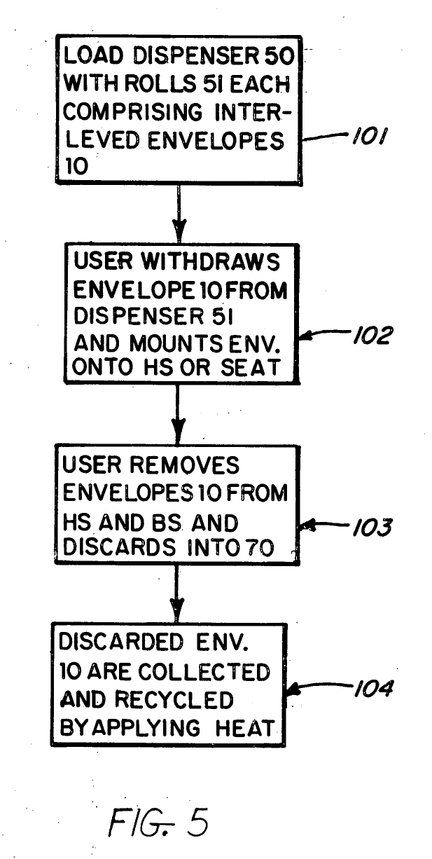

Thus a dispensing and collection process is conveniently established by the complementary attributes of the envelopes 10, the conveniently deployed dispensers 50 and also the collection receptacles 70 which has many aspects that are currently becoming familiar to the consuming public. More precisely, as shown in FIG. 5, the initial step 101 of the foregoing process entails the loading of the dispensers 50 with rolls 51 comprising a dispensing sequence of envelopes 10 which are then, in step 102, mounted by the visiting user onto those parts of an exercise device onto which contact is made. Following use, in step 103 the envelopes 10 are removed by the user from the exercise device and discarded into the collection receptacles 70 to be thereafter collected and recycled in step 104 to emerge once again as rolls 51.

Preferably the polymeric material of each envelope 10 is of the thermoplastic form selected to melt in the course of the recycling step 104 at temperatures equal or higher than the sterilization temperatures of biological matter. For example, those in the art will appreciate that polymers like high and low density polyethylene, and similar linear polymers, melt at temperatures substantially higher than the usual biological sterilization temperatures with very little or no cross linking that may perhaps come with time and recycling repetitions. These linear polymers make up about 60% of the organic polymers now in use and therefore their continuous supply is assured. In this manner a closed process is implemented in which little, or no, cross contamination is possible, a process enabled by convenient securing mechanisms that tie the envelope to the areas shielded that are also conveniently untied without much manipulation. Of course, these same securement mechanisms are also useful as handles when the shielding envelopes are discarded.

Thus all, or at least most of the sanitary concerns associated with public exercise facilities are addressed along with the conservation concerns that now trouble the general public in a process that combines the inherent heat of recycling as also its sterilization modality. All the benefits of the most advanced exercise devices can therefore be conveniently shared, enhancing the prospective business profits and any return on investment.

Obviously many modifications and variations of the instant invention can be effected without departing from the spirit of the teachings herein. It is therefore intended that the scope of the invention be determined solely by the claims appended hereto.

It is claimed:

1. A method of shielding the common contact portions of exercise devices in a public exercise facility, comprising the steps of:
dispensing thin polymeric film envelopes from dispensers distributed in said facility, each said envelope forming a generally flexible rectangular enclosure open along one edge thereof and dimensioned to receive and enclose one of said common contact portions;
securing one of said polymeric envelopes in an enclosing alignment surrounding a selected one of said contact portions;
releasing said one of said polymeric film envelopes from the securement thereof in surrounding alignment on said selected one of said common contact portions; and
collecting the released ones of said polymeric film envelopes.

2. A method according to claim 1, further comprising the step of:
recycling the collected polymeric film envelopes to provide newly formed ones of said polymeric film envelopes.

3. A method according to claim 2, further comprising the step of:
inserting said newly formed ones of said polymeric film envelopes into said dispensers.

4. A method according to claim 2, wherein:
the step of recycling includes the further step of heating of said collected polymeric film envelopes.

5. A method according to claim 4, further comprising the step of:
inserting said newly formed ones of said polymeric film envelopes into said dispensers.

6. A discardable thin film polymeric envelope useful to enclose and shield the common contact portions of exercise devices deployed for shared use in a public exercise facility, comprising:
an upper and a lower membrane each of substantially equal rectangular planforms joined to each other along three edges thereof to form an enclosure provided with an opening formed between the unjoined fourth edges, each said planform and said opening being dimensioned to receive said common contact portions, said upper membrane including a substantially transparent portion; and
an elongate band deployed along said opening for releasably closing said opening and thereby securing said envelope in surrounding alignment about said common contact portion received therein.

7. A discardable thin film polymeric envelope according to claim 6, wherein:
said envelope comprises a thermoplastic polymeric material structure.

8. A dispenser useful in deploying a roll of interleaved thin film polymeric envelopes for selective sequential withdrawal thereof in a publicly utilized exercise facility, comprising:
a generally vertical, hollow thin-walled cylindrical housing conformed to receive said roll of interleaved envelopes, said housing including a lateral opening in the exterior wall thereof conformed for serial withdrawal of said envelopes therethrough.

9. A dispenser according to claim 8, wherein each said envelope further includes:
an upper and a lower membrane each of substantially equal rectangular planforms joined to each other along three edges thereof to form an enclosure provided with an opening formed between the unjoined fourth edges, the closed portion of one envelope being received in the opening of the next adjacent envelope on said roll.

10. A dispenser according to claim 9, wherein each said envelope further includes:
an elongate band deployed along said opening for releasably closing said opening.

11. A dispenser according to claim 10, wherein each said envelope further comprises:
a thermoplastic polymeric material structure.

12. An assemblage of cooperative parts including dispenser useful in deploying a roll of interleaved thin film polymeric envelopes for selective sequential withdrawal thereof to enclose and shield the common contact portions of exercise devices deployed for shared use in a public exercise facility and a collection receptacle for collecting the discarded ones of said envelopes following exercise use, comprising:
a generally vertical, hollow thin-walled cylindrical housing conformed to receive said roll of interleaved envelopes, said housing including a lateral opening in the exterior wall thereof conformed for serial withdrawal of said envelopes therethrough, each said envelope including an upper and a lower membrane each of substantially equal rectangular planforms joined to each other along three edges thereof to form an enclosure provided with an opening formed between the unjoined fourth edges, each said planform and said opening being dimensioned to receive said common contact portions, said upper membrane including a substantially transparent portion; and
an elongate band deployed along said opening for releasably closing said opening and thereby securing said envelope in surrounding alignment about said common contact portion received therein.

13. An assemblage of cooperative parts according to claim 12, wherein:
the closed portion of one envelope being received in the opening of the next adjacent envelope on said roll of interleaved envelopes.

14. An assemblage of parts according to claim 13, wherein each said envelope further comprises:
a thermoplastic polymeric material structure.

15. An assemblage of parts according to claim 14, wherein:
each said collection receptacle is conformed to collect the discarded ones of said envelopes for recycling by applying heat thereto.
